(19) United States
(12) Patent Application Publication
(10) Pub. No.: US 2008/0057936 A1
(43) Pub. Date: Mar. 6, 2008

(54) Electronic apparatus and device detection method

(75) Inventor: Hajime Oosawa, Kokubunji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/896,199

(22) Filed: Aug. 30, 2007

(30) Foreign Application Priority Data
Sep. 1, 2006 (JP) 2006-237957

(51) Int. Cl. H04Q 7/22

(52) U.S. Cl. 455/422.1; 455/556.1

(57) ABSTRACT

According to one embodiment, there is provided an electronic apparatus adapted to execute wireless communication with another device. The apparatus includes a module that executes the wireless communication, and a driver that causes the module to execute a scan process for detecting a device existing around the electronic apparatus by broadcasting a probe request packet and receiving a probe response packet corresponding to the probe request packet, thereby generating a device list of detected devices. The module further receives a probe request packet broadcasted from a device other than the electronic apparatus during the scan process, and the driver acquires information included in the probe request packet and adds the device to the device list.

### CROSS-REFERENCE TO RELATED APPLICATIONS

This application is based upon and claims the benefit of priority from Japanese Patent Application No. 2006-237957, filed Sep. 1, 2006, the entire contents of which are incorporated herein by reference.

### BACKGROUND

1. Field

One embodiment of the invention relates to an electronic apparatus having a radio communication function and a device detection method applicable to the electronic apparatus.

2. Description of the Related Art

A wireless device having a wireless local area network (LAN) function compliant with IEEE 802.11b/g detects surrounding wireless devices located in active scanning and passive scanning. In the active scanning, the wireless device broadcasts a probe request packet (frame) to each of channels, and receives a probe response packet (frame) in reply to the request. Thus, the wireless device can detect existence of surrounding stations or the like. In the passive scanning, the wireless device can detect existence of surrounding stations or the like by receiving beacons, which access points or stations of an ad hoc mode periodically transmit.

Various prior art to efficiently perform the active scanning is known. For example, Jpn. Pat. Appln. KOKAI Publication No. 2006-196946 discloses a technique to efficiently search terminal apparatuses with low power consumption. In this prior art, an electronic apparatus broadcasts a probe request with a field intensity of the radio communication set at the minimum value. If there is no response signal from a new or any other terminal apparatus, the electronic apparatus increases the set value of the field intensity by a degree and broadcasts a probe request with the increased field intensity.

In the conventional methods including the art described in the above publication, however, many devices may not be detected for some reason, for example, the position of the devices or radio interference, even if they are located in a range where radio communication is possible.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic view showing an electronic apparatus according to an embodiment of the present invention;

FIG. 2 is an exemplary block diagram showing a system configuration of the electronic apparatus shown in FIG. 1;

FIG. 3 is an exemplary block diagram showing an example of configurations of an application program and a wireless LAN driver in the electronic apparatus of FIG. 1;

FIG. 4 is an exemplary schematic diagram showing a configuration of a probe request packet;

FIG. 5 is an exemplary schematic diagram showing a configuration of a probe response packet;

FIG. 6 is an exemplary diagram showing an example of control which permits detection of a greater number of devices;

FIG. 7 is an exemplary diagram showing an example of control which reduces traffic of radio communication;

FIG. 8 is an exemplary diagram showing an example of a device list generated on the basis of results of a scanning process;

FIG. 9 is an exemplary flowchart showing an example of an operation which permits detection of a greater number of devices; and

FIG. 10 is an exemplary diagram showing an example of an operation which reduces traffic of radio communication.

### DETAILED DESCRIPTION

Various embodiments according to the invention will be described hereinafter with reference to the accompanying drawings. In general, according to one embodiment of the invention, there is provided an electronic apparatus adapted to execute wireless communication with another device. The apparatus includes a module that executes the wireless communication, and a driver that causes the module to execute a scan process for detecting a device existing around the electronic apparatus by broadcasting a probe request packet and receiving a probe response packet corresponding to the probe request packet, thereby generating a device list of detected devices. The module further receives a probe request packet broadcasted from a device other than the electronic apparatus during the scan process, and the driver acquires information included in the probe request packet and adds the device to the device list.

First, the configuration of an electronic apparatus according to an embodiment of the present invention will be described with reference to FIG. 1.

The electronic apparatus is a portable apparatus, such as a personal computer, PDA or audio/video (AV) player, and can be driven by an internal battery. In the following description, it is assumed that the information processing apparatus is implemented as, an AV player 11 which plays back audio data and video data.

An LCD 12 as a display device and various operation buttons (a back button 13, a start button 14, an OK button 15 and a plus button 16) as input devices are provided on the surface of the main body of the AV player 11. Headphones 17 are connected to a headphone terminal provided on, for example the upper surface of the main body of the AV player 11.

The AV player 11 has a wireless communication function, such as a wireless LAN compliant with the IEEE 802.11b/g standards. It can execute wireless communication with wireless devices (access point (AP) 21 and station (STA) 31), which are compliant with the IEEE 802.11b/g standards. For example, the AV player 11 can be wirelessly connected to the access point (AP) 21 and access a server on the Internet via the access point (AP) 21, so that it can download audio data and video data from the server. The station (STA) 31 includes, for example, a personal computer and another AV player having the same wireless communication function as that of the AV player 11. The AV player 11 is wirelessly connected to the station (STA) 31, so that audio data, video data, etc. can be exchanged with the station (STA) 31.

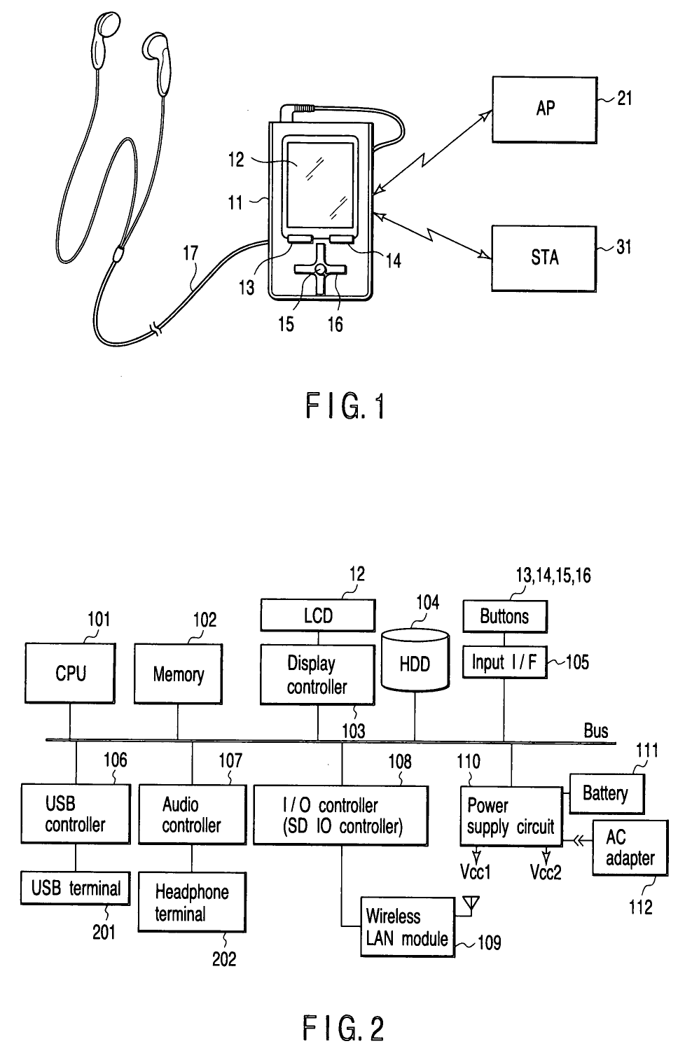

The system configuration of the AV player 11 will now be described with reference to FIG. 2.

As shown in FIG. 2, the AV player 11 includes a CPU 101, a memory 102, a display controller 103, a hard disk drive (HDD) 104, an input interface 105, a USB controller 106, an audio controller 107, an I/O controller 108, a wireless LAN module 109, a power supply circuit 110, a battery 111, etc.

The CPU 101 is a processor that controls operations of the AV player 11. It executes various programs (the operating system, application program wireless LAN driver, etc.), which are loaded in the memory 102. The application program is a program to play back audio data and video data and execute wireless communication. The wireless LAN driver is a driver program to control the wireless LAN module 109 upon request of the application program.

The display controller 103 controls the LCD 12, and displays on the display screen of the LCD 12 operation menus, images corresponding to the video data played back by the application program, etc. The HDD 104 functions as a storage device to store various data, such as audio data and video data. The USB controller 106 is connected to a USB terminal 201 provided on the main body of the AV player 11. It executes communication with another devices connected to the USB terminal 201. The audio controller 107 is a sound source device. It generates a sound signal corresponding to the audio data played back by the application program, and outputs the sound signal to the headphone terminal 202. The I/O controller 108 is a controller to execute the interface to the wireless LAN module 109. It includes, for example, an SD IO host controller to control an SD IO card. In this case, the I/O controller 108 is connected to the wireless LAN module 109 via an SD IO bus.

The wireless LAN module 109 is a wireless communication module, which executes wireless communication compliant with, for example, the IEEE 802.11b/g standards. The IEEE 802.11b/g standards define thirteen wireless communication channels, that is, channels 1 to 13, which are different in carrier frequency. The wireless LAN module 109 can execute wireless communication using any one of the thirteen wireless communication channels.

The power supply circuit 110 supplies operation powers to the respective components, using the power from the battery 111 in the main body of the AV player 11 or external power supplied through an AC adapter 112.

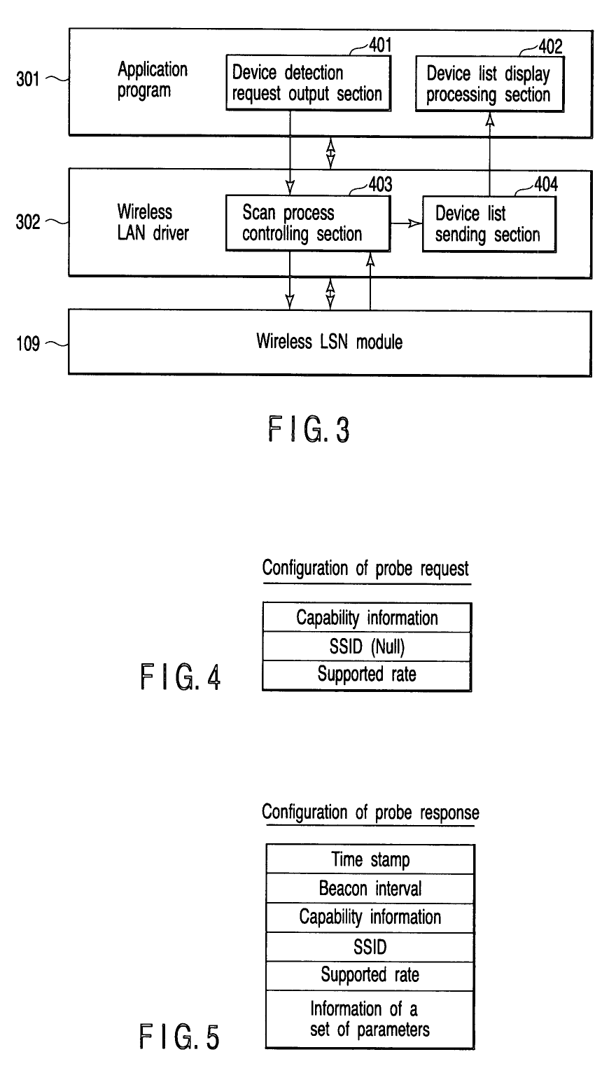

Referring to FIG. 3, a function for efficiently detecting wireless devices (AP and STA) locating around the AV player 11 will be described. FIG. 3 shows the relationship among an application program 301, a wireless LAN driver 302 and the wireless LAN module 109.

The application program 301 is a program to transmit various content data (audio data, video data, etc.) to the wireless devices by wireless communication. It receives various operation requests relating to the wireless communication function from the user by means of GUI. It executes communication with the wireless LAN driver 302 in accordance with the operation requests. The application program 301 includes a device detection request output section 401 and a device list display processing section 402. The device detection request outputting section 401 and the device list display processing section 402 are software modules, which are executed by the CPU 101.

The device detection request output section 401 sends a wireless device detection request to instruct execution of a scan process to the wireless LAN driver 302 in response to a request for detecting a wireless device from the user. The device list display processing section 402 displays on the display screen of the LCD 12 a device list indicative of wireless devices detected by the scan process executed by the wireless LAN module 109.

The wireless LAN driver 302 is a program that controls the wireless LAN module 109 in accordance with the request from the application program 301. The wireless LAN driver 302 causes the wireless LAN module 109 to execute the scan process requested by the application program 301, and generates a device list indicative of wireless devices detected by the scan process. The wireless LAN driver 302 includes a scan process controlling section 403 and a device list sending section 404. The scan process controlling section 403 and the device list sending section 404 are software modules, which are executed by the CPU 101.

The scan process controlling section 403 sends a scan request to the wireless LAN module 109, when the application program 301 outputs a wireless device detection request in response to a request from the user. Then, it causes the wireless LAN module 109 to execute a scan process for each of the wireless communication channels 1 to 13. In this embodiment, it is assumed that the active scanning is applied to the scan process. Generally, in the active scanning, a wireless device broadcasts a probe request packet (Probe req.), and waits for a probe response packet (Probe res.) from a surrounding wireless device. By the receipt of the probe response packet (Probe res.), the wireless device can obtain information on the surrounding wireless device (e.g., the MAC address, the service set identifier (SSID), the type of the device, etc.) to identify the surrounding wireless device which transmitted the probe response packet (Probe res.).

During the scan process, the scan process controlling section 403 generates a device list indicative of wireless devices based on the information obtained from the respective probe response packets received by the wireless LAN module 109. Further, when the scan process controlling section 403 receives a notification representing termination of the scan process from the wireless LAN module 109, it instructs the device list sending section 404 to send the generated device list to the application program 301.

The device list sending section 404 sends the generated device list to the application program 301 in accordance with the instruction from the scan process controlling section 403.

When the wireless LAN module 109 receives a request for a scan process from the wireless LAN driver 302, it executes the requested scan process for a fixed period. The wireless LAN module 109 broadcasts a probe request packet, and then waits for a probe response packet transmitted from another wireless device. During the scan process, each time the wireless LAN module 109 receives a probe response packet, it notifies the scan process controlling section 403. Further, when the scan process is timed out, the wireless LAN module 109 notifies the scan process controlling section 403 of the termination of the scan process.

In particular, during the scan process, the wireless LAN module 109 receives not only the probe response packet transmitted to the AV player 11 but also the probe response packet transmitted to any device other than the AV player 11. At that time, the scan process controlling section 403 acquires information (the type and capability of the device, the SSID, etc.) included in the probe response packet transmitted to another device, and carries out a process to add the device to the device list.

During the scan process, the wireless LAN module 109 further receives a probe request packet transmitted from any device other than the AV player 11. At that time, the scan process controlling section 403 may acquire information (the type and capability of the device, the SSID, etc.) included in the probe request packet, and carries out a process to add the device to the device list.

Further, the scan process controlling section 403 may be configured to perform the control to determine whether there is a probe request packet broadcasted from any device other than the AV player 11 at a start of the scan process. If it determines that such a probe request packet is present, the scan process controlling section 403 may wait for reception of a probe response packet transmitted to the device other than the AV player 11 without carrying out the broadcast transmission.

FIG. 4 is a schematic diagram showing a configuration of a probe request packet.

The probe request packet is formed of a plurality of sub-fields to store various information items, such as capability information, an SSID, and a supported rate. However, if the packet is broadcasted by a station, the SSID is not designated (“Null”). When a wireless device receives the packet, it can identify the type and capability of the sender device by fetching the various information in the sub-fields, thereby detecting the presence of a surrounding station, etc.

FIG. 5 is a schematic diagram showing a configuration of a probe response packet.

The probe response packet is formed of a plurality of sub-fields to store various information items, such as a time stamp, a beacon interval, capability information, an SSID, a supported rate, and a set of various parameters. In this embodiment, when the AV player 11 receives the packet, it can identify the type and capability of the sender device by fetching various information items in the sub-fields. Therefore, it can also recognize, for example, the SSID corresponding to the identification number of the network forming the access point.

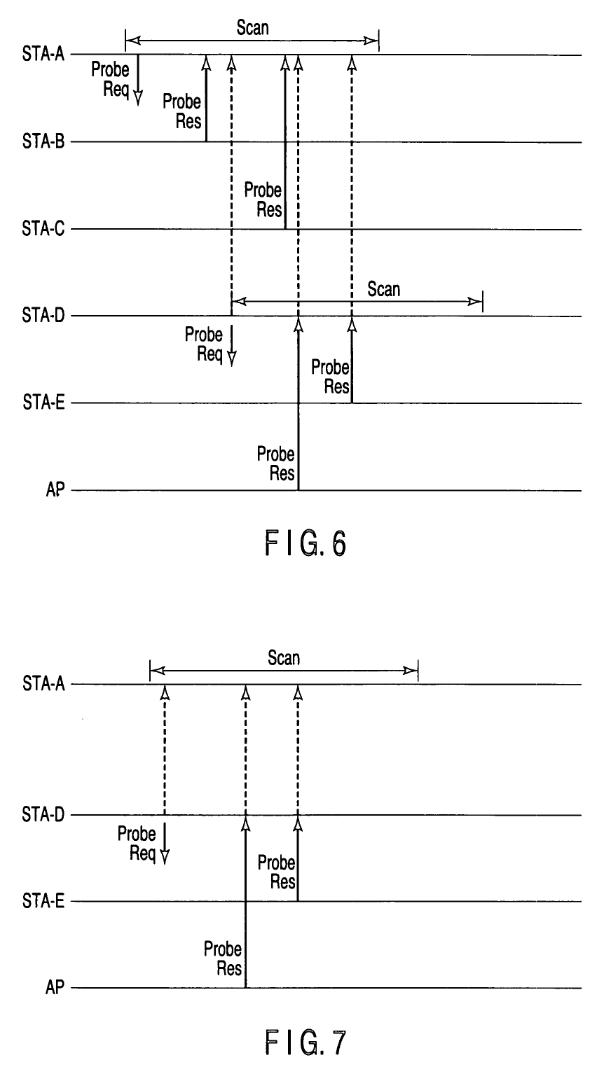

FIG. 6 is a diagram showing an example of control which permits detection of a greater number of devices.

In the following description, it is assumed that the station STA-A in FIG. 6 is the AV player 11. In the communication area of the station STA-A, stations STA-B, STA-C, STA-D and STA-E and an access point AP are present.

When the STA-A starts a scan process and broadcasts a probe request packet, a device that detect the probe request packet sends back a probe response packet to the station STA-A. For example, it is assumed that the stations STA-B and STA-C normally send back probe response packets, while the stations STA-D and STA-E and the access point AP do not send back probe response packets for some reason.

Under these circumstances, it is assumed that the station STA-D broadcasts a probe request packet during the scan process of the station STA-A, and the access point AP and the station STA-E send back probe response packets to the station STA-D. In this case, the station STA-A receives the probe request packet broadcasted by the station STA-D and also the probe response packets respectively sent from the access point AP and the station STA-E. Even if the packets are not addressed to the station STA-A itself, the station STA-A, which received them, does not dispose of them but fetches (reads in secrecy) the information therein and makes an addition to the device list.

Thus, the station STA-A can detect the presence of the stations STA-D and STA-E and the access point AP as well as the stations STA-B and STA-C. In addition, it can recognize the SSID or the like of the network which the access point AP forms. Particularly, if the access point AP is an access point to which a hidden SSID is set, it will not send back a probe response packet, unless it receives a probe request packet designating the SSID. However, according to this embodiment, the station STA-A can recognize the SSID of the access point AP from the probe response packet sent from the access point AP to another station which has recognized the SSID. Then, the station STA-A can send a probe request packet designating the SSID to the access point AP, and receive a probe response packet sent back from the access point AP. As a result, it is possible to detect the access point AP.

FIG. 7 is a diagram showing an example of control which reduces traffic of radio communication.

In the following description, it is also assumed that the station STA-A in FIG. 7 is the AV player 11. In the communication area of the station STA-A, stations STA-B, STA-C, STA-D and STA-E and an access point AP are present (though the stations STA-B and STA-C are not shown). In the following, the control will be described, mainly focusing on differences from FIG. 6.

At a start of the scan process, the station STA-A determines for a fixed period whether there is a probe request packet broadcasted from any station other than itself. If the station STA-A determines that there is no such a probe request packet, it broadcasts a probe request packet as described above referring to FIG. 6. On the other hand, if there is such a probe request packet, the station STA-A does not broadcast a probe request packet, but wait for reception of a probe response packet sent to any device other than the STA-A.

For example, if the station STA-A detects a probe request packet broadcasted from the station STA-D, it does not broadcast a probe response packet but waits for a probe response packet to be sent back to the station STA-D. When the access point AT and the station STA-E (and the stations STA-B and STA-C not shown) respectively send probe response packets to the STA-D, the station STA-A receives those packets. Even if the packets are not addressed to the station STA-A itself, the station STA-A, which received them, does not dispose of them but fetches (reads in secrecy) the information therein and makes an addition to the device list, as described above referring to FIG. 6.

Thus, in the case where the station STA-A detects a probe request packet broadcasted from any station other than itself at a start of the scan process, it does not broadcast a probe request packet. Therefore, the station STA-A can reduce the traffic among devices and detect a greater number of devices. Further, if other stations have this control function of the station STA-A, the traffic in the entire wireless system can be reduced.

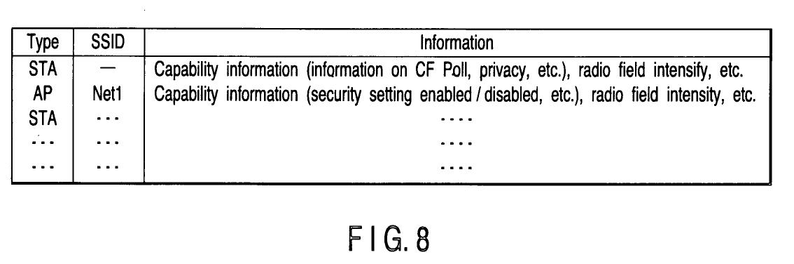

FIG. 8 is a diagram to explain an example of a device list.

The device list includes type information indicative of types of a station (STA) and an access point (AP), an SSID acquired from the access point or the like, capability information, radio field intensity, a MAC address, etc. The device list display processing section 402 displays the device list on the display screen of the LCD 12 in a form that the user can easily recognize. For example, the type information may be indicated by an iron or the like; that is, only the information necessary to the user is displayed.

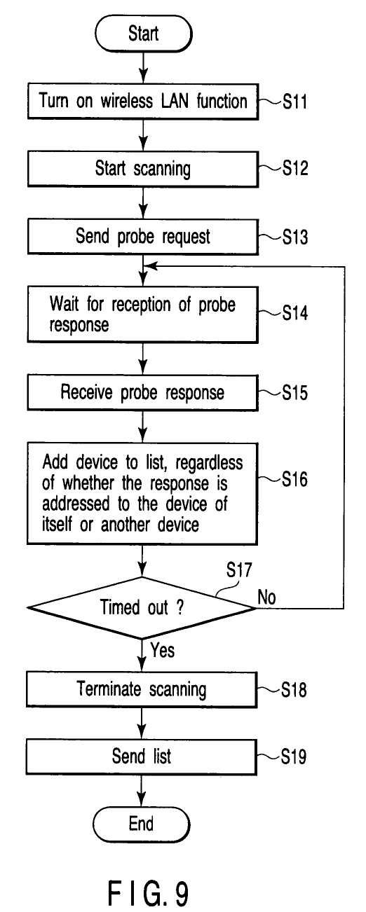

An example of an operation which permits detection of a greater number of devices will be described with reference to FIG. 9.

The scan process controlling section 403 provided in the wireless LAN driver 302 starts a scan process in reply to a scan request in the state where the wireless LAN function is on (blocks S11 and S12).

In the scan process, the scan process controlling section 403 causes the wireless LAN module 109 to broadcast a probe request packet (block S13), and waits for a probe response packet in reply thereto to be received (block S14). When the wireless LAN module 109 receives the probe response packet sent back (block S15), the scan process controlling section 403 fetches the information in the packet and adds a device to the device list, regardless of whether the packet is addressed to the device of itself or another device (block S16). If the scan process is not timed out (NO in block S17), the process of blocks S14 to S16 is repeated. If the scan process is timed out (YES in block S17), the scan process controlling section 403 terminates the scan process (block S18), and causes the device list sending section 404 to send the generated device list to the device list display processing section 402 on the side of the application 301 (block S19). Thus, the device list display processing section 402 displays the device list on the display screen of the LCD 12 in the form that the user can easily recognize.

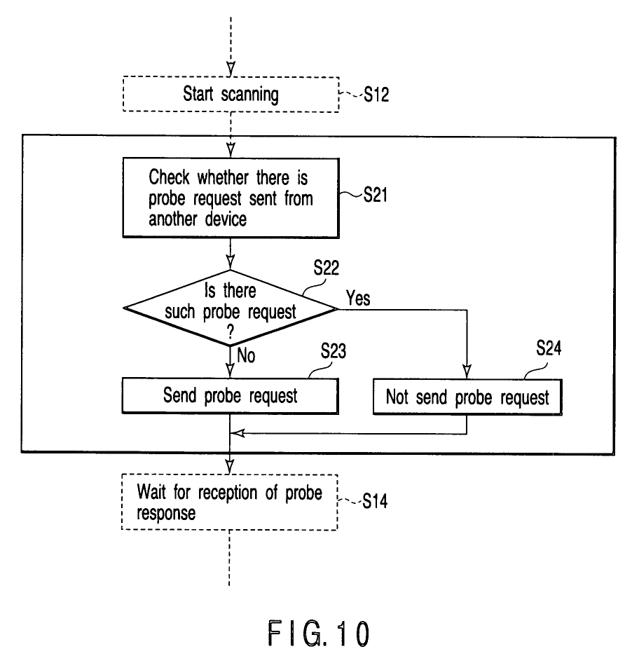

An example of the operation which reduces the traffic of wireless communication will now be described with reference to FIG. 10, also referring to FIG. 9.

In the operation of FIG. 9, after starting the scan process (block S12), the probe request packet is sent unconditionally (block S13). Instead, the embodiment can be modified such that the probe request packet may be sent only when necessary, after determining whether the probe request packet need be sent or not.

More specifically, after the scan process is started (block S12), the scan process controlling section 403 determines in a fixed period whether there is a probe request packet broadcasted from any station other than the station of itself (block S21), as shown in FIG. 10. If there is no such a probe request packet (NO in block S22), the scan process controlling section 403 broadcasts a probe request packet (block S23). If there is such a probe packet request, it does not broadcast a probe request packet (block S24).

Thereafter, the process from block S14 to block S19 shown in FIG. 9 is carried out.

As has been described, according to the above embodiment, a greater number of stations or the like can be detected as compared to the conventional detection method. Further, it is possible to detect an access point to which a hidden SSID is set. Furthermore, since the number of probe request packets sent out from a wireless communication device can be reduced, the traffic on wireless communication can be reduced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus adapted to execute wireless communication with another device, the apparatus comprising:
a module that executes the wireless communication; and
a driver that causes the module to execute a scan process for detecting a device existing around the electronic apparatus by broadcasting a probe request packet and receiving a probe response packet corresponding to the probe request packet, thereby generating a device list of detected devices,
the module further receiving a probe request packet broadcasted from a device other than the electronic apparatus during the scan process, and the driver acquiring information included in the probe request packet and adding the device to the device list.

2. The electronic apparatus according to claim 1, wherein the information included in the probe request packet includes capability information relating to a sender device.

3. The electronic apparatus according to claim 1, wherein the module further receives a probe response packet sent to a device other than the electronic apparatus during the scan process, and the driver acquires information included in the probe response packet and adds the device to the device list.

4. The electronic apparatus according to claim 3, wherein the information included in the probe response packet includes a service set identifier to identify a network.

5. The electronic apparatus according to claim 1, wherein the driver determines whether there is a probe request packet broadcasted from a device other than the electronic apparatus at a start of the scan process, and if it determines that there is, the driver waits for reception of a probe response packet transmitted to the device other than the electronic apparatus without broadcasting the probe request packet.

6. A device detection method applicable to an electronic apparatus having a module that executes wireless communication with another device, the method comprising:
causing the module to execute a scan process for detecting a device existing around the electronic apparatus by broadcasting a probe request packet and receiving a probe response packet corresponding to the probe request packet, thereby generating a device list of detected devices; and
receiving a probe request packet broadcasted from a device other than the electronic apparatus during the scan process, acquiring information included in the probe request packet and adding the device to the device list.

7. The device detection method according to claim 6, wherein the information included in the probe request packet includes capability information relating to a sender device.

8. The device detection method according to claim 6, further comprising receiving a probe response packet sent to a device other than the electronic apparatus by the module during the scan process, acquiring information included in the probe response packet and adding the device to the device list.

9. The device detection method according to claim 8, wherein the information included in the probe response packet includes a service set identifier to identify a network.

10. The device detection method according to claim 6, further comprising determining whether there is a probe request packet broadcasted from a device other than the electronic apparatus at a start of the scan process, and if it is determined that there is, waiting for reception of a probe response packet transmitted to the device other than the electronic apparatus without broadcasting the probe request packet.
